(19) United States
(12) Patent Application Publication
(10) Pub. No.: US 2015/0295279 A1
(43) Pub. Date: Oct. 15, 2015

(54) MOLTEN SALT BATTERY AND METHOD FOR PRODUCING SAME

(71) Applicant: Sumitomo Electric Industries, Ltd., Osaka-shi (JP)

(72) Inventors: Koma Numata, Osaka-shi (JP); Shinji Inazawa, Osaka-shi (JP); Koji Nitta, Osaka-shi (JP); Shoichiro Sakai, Osaka-shi (JP); Atsushi Fukunaga, Osaka-shi (JP); Eiko Imazaki, Osaka-shi (JP)

(21) Appl. No.: 14/648,074

(22) PCT Filed: Oct. 15, 2013
(86) PCT No.: PCT/JP2013/077890

§ 371 Date: May 28, 2015

(30) Foreign Application Priority Data
Nov. 28, 2012 (JP) 2012-259608

(51) Int. Cl. H01M 10/39; H01M 10/38

(52) U.S. Cl. CPC H01M 10/399; H01M 10/38; H01M 2300/0054

(57) ABSTRACT

A molten salt battery comprising a positive electrode, a negative electrode, a separator interposed between the positive electrode and the negative electrode, and an electrolyte, wherein the electrolyte includes a molten salt, the molten salt contains at least sodium ions, and the moisture content We1 in the molten salt is 300 ppm or less in terms of mass ratio.

### TECHNICAL FIELD

The present invention relates to a molten salt battery in which precipitation of sodium dendrites is suppressed.

### BACKGROUND ART

In recent years, the technology of converting natural energy of sunlight, wind power, or the like to electric energy has attracted attention. Also, non-aqueous electrolyte secondary batteries have been increasingly demanded as batteries with high energy densities capable of storing much electric energy. Among the non-aqueous electrolyte secondary batteries, lithium ion secondary batteries are promising in view of lightness of weight and high electromotive force. However, lithium ion secondary batteries each contain a combustible organic electrolyte and thus require high cost for securing safety and are difficult to continuously use in a high-temperature region. Further, the price of lithium resources is increasing.

Therefore, the development of molten salt batteries using a flame-retardant molten salt as an electrolyte are advanced. Molten salts have excellent thermal stability and safety which can be relatively easily secured, and are suitable for continuous use in a high-temperature region. Also, the molten salt batteries can use as an electrolyte a molten salt containing cation of an inexpensive alkali metal (particularly sodium) other than lithium, thereby decreasing the production cost.

For example, a mixture of sodium bis(fluorosulfonyl)amide (NaFSA) and potassium bis(fluorosulfonyl) amide (KFSA) has been developed as a molten salt having a low melting point and excellent thermal stability (Patent Literature 1).

Also, a sodium-containing transition metal oxide such as sodium chromite has been proposed to be used as a positive electrode active material of a positive electrode of a molten salt battery. On the other hand, sodium, a sodium alloy, a metal that is alloyed with sodium, a carbon material, a ceramic material, or the like has been proposed to be used as a negative electrode active material of a negative electrode. In particular, metals such as zinc, tin, silicon, and the like are relatively inexpensive and are expected as negative electrode materials with which high capacity can be achieved (Patent Literature 2 and Patent Literature 3).

### CITATION LIST

### Patent Literature

PTL 1: Japanese Unexamined Patent Application Publication No. 2009-67644

PTL 2: Japanese Unexamined Patent Application Publication No. 2011-192474

PTL 3: Japanese Unexamined Patent Application Publication No. 2011-249287

### SUMMARY OF INVENTION

### Technical Problem

However, usual molten salt batteries have the problem of easily precipitating sodium dendrites on negative electrodes regardless of the types of negative electrode active materials. For example, when a molten salt battery is repeatedly charged and discharged over a long period of time, sodium dendrites grow from a negative electrode toward a positive electrode, penetrate a separator, and then reach the positive electrode, and thus internal short-circuiting may occur. Also, when the growing dendrites fall off from the negative electrode, falling sodium cannot contribute to charge-discharge reaction, thereby decreasing the capacity of the molten salt battery.

In a molten salt battery, the moisture content in the battery has been decreased to a certain level from the viewpoint of suppressing side reactions of a molten salt other than the charge-discharge reaction. The occurrence of hydrolysis reaction as a side reaction may cause chemical damage to a separator due to a reaction product or may inhibit the smooth electrode reaction due to the reaction product serving as a resistance component. Therefore, the positive electrode, the negative electrode, the separator, and the molten salt are generally dried before a molten salt battery is assembled. The moisture content in each of the positive electrode, the negative electrode, the separator, and the molten salt after drying is decreased to about 400 ppm to 1000 ppm in terms of mass ratio.

However, it is becoming known that in a molten salt battery, not only the side reactions of the molten salt but also the degree of precipitation of sodium dendrites are greatly influenced by the moisture content in the battery. Also, it is becoming known that the occurrence frequency of internal short-circuiting due to dendrites is very sensitive to the moisture content in a battery, and it is unsatisfactory to only decrease the moisture content to the same level as usual.

The reason for this is not clear, but a conceivable reason is that the molten salt battery can be used at a relatively high temperature and thus exhibits high reactivity between sodium and moisture. Specifically, reaction of sodium with moisture produces a sodium oxide, and sodium dendrites grow from a position as a starting point where the sodium oxide is produced.

Therefore, in order to suppress short-circuiting between a positive electrode and a negative electrode, it is important to more decrease the moisture content in a molten salt battery than usual. Also, it is particularly important to control the moisture content in a migration path of sodium ions, that is, in a separator, between the positive electrode and the negative electrode.

### Solution to Problem

Movable moisture of the moisture contained in a positive electrode, a negative electrode, and a separator is considered to move to a molten salt in a battery. In addition, the separator is interposed between the positive electrode and the negative electrode, and the molten salt is impregnated into voids of the separator. Therefore, in order to decrease the moisture content in a migration path of alkali metal ions for suppressing internal short-circuiting, it is necessary to strictly control the moisture content in the molten salt.

In view of the above, in an aspect of the present invention, the present invention relates to a molten salt battery including a positive electrode, a negative electrode, a separator interposed between the positive electrode and the negative electrode, and an electrolyte, wherein the electrolyte includes a molten salt, the molten salt contains at least sodium ions, and the moisture content We1 in the molten salt is 300 ppm or less in terms of mass ratio. In the molten salt battery, the precipitation of sodium dendrites can be suppressed, and thus the frequency of occurrence of internal short-circuiting can be greatly decreased.

In another aspect of the present invention, the present invention relates to an example of a method for producing the molten salt battery. The method includes a step of preparing the positive electrode having a moisture content Wp of 300 ppm or less in terms of mass ratio, a step of preparing the negative electrode having a moisture content Wn of 400 ppm or less in terms of mass ratio, a step of preparing, as the electrolyte, the molten salt having a moisture content We2 of 50 ppm or less in terms of mass ratio and containing at least sodium ions, a step of preparing the separator having a moisture content Ws of 350 ppm or less in terms of mass ratio, and a step of stacking the positive electrode and the negative electrode with the separator interposed therebetween to form an electrode group and impregnating the electrode group with the molten salt. That is, in the method, the moisture contents in not only the molten salt but also the positive electrode, the negative electrode, and the separator are strictly controlled.

The moisture content We1 in the molten salt of the molten salt battery is preferably 300 ppm or less in terms of mass ratio. Also, when the moisture content We1 is decreased to 200 ppm or less, the effect of suppressing the occurrence of internal short-circuiting becomes significant, and more excellent cycle characteristics can be achieved.

The molten salt preferably includes at least one selected from the group consisting of compounds represented by N(SO₂X¹)(SO₂X²)·M (wherein X¹ and X² are each independently a fluorine atom or a fluoroalkyl group having 1 to 8 carbon atoms, and M is an alkali metal or an organic cation having a nitrogen-containing hetero-ring). The molten salt contains at least the compound containing sodium ion as M. Thus, the molten salt battery can be used even at a high temperature of, for example, 70° C. or more. Further, the moisture content We1 in the molten salt of the molten salt battery is decreased to 300 ppm or less and further decreased to 200 ppm or less, and thus even the long-term use of the molten salt battery a high temperature causes little reaction of sodium ions with moisture. Therefore, dendrites little grow from a sodium oxide, as a starting point, produced by reaction of sodium with moisture.

In a preferred form, the molten salt includes a mixture of sodium bis(fluorosulfonyl) amide (NaFSA) and potassium bis(fluorosulfonyl) amide (KFSA) at a molar ratio NaFSA/KFSA=40/60 to 70/30. In another preferred form, the molten salt includes a mixture of methylpropylpyrrolidinium bis(fluorosulfonyl) amide (Py13FSA) and sodium bis(fluorosulfonyl) amide (NaFSA) at a molar ratio Py13FSA/NaFSA=97/3 to 80/20. By using such a molten salt, the molten salt battery which can be used even at a relatively low temperature can be produced, resulting in an increase in the effect of suppressing the formation of dendrites.

In a preferred form, the negative electrode includes a negative electrode current collector composed of a first metal and a second metal which covers at least a portion of the surface of the negative electrode current collector. The first metal is a metal which is not alloyed with sodium, and the second metal is a metal which is alloyed with sodium. More specifically, the molten salt battery contains aluminum or an aluminum alloy as the first metal and tin, a tin alloy, zinc, or a zinc alloy as the second metal. The negative electrode having such a structure causes repeated precipitation and dissolution of sodium with charge and discharge and thus has the high necessity for suppressing the formation of dendrites. Even in the use of the negative electrode in which precipitation and dissolution of sodium are repeated, cycle characteristics can be significantly improved by decreasing the moisture content We1 in the molten salt of the molten salt battery to 300 ppm or less.

In another preferred form, the negative electrode includes a negative electrode current collector composed of a first metal and a negative electrode active material layer formed on the surface of the negative electrode current collector. The first metal is a metal which is not alloyed with sodium, and the negative electrode active material layer contains as a negative electrode active material at least one selected from the group consisting of sodium-containing titanium compounds and hardly graphitizable carbon. The negative electrode having such a structure originally causes little formation of dendrites with charge and discharge. However, when the molten salt battery is over-charged or the battery is contaminated with foreign matter, dendrites may occur. On the other hand, even when the above-described unexpected situation occurs, the possibility of occurrence of dendrites is significantly decreased by decreasing the moisture content We1 in the molten salt of the molten salt battery to 300 ppm or less. Therefore, the reliability of the molten salt battery can be significantly improved.

In a preferred form, the positive electrode includes a positive electrode current collector and a positive electrode active material layer formed on the surface of the positive electrode current collector. The positive electrode active material layer contains as a positive electrode active material Na₁₋ₓM¹ₓCr_{1-y}M²_{y}O₂ (0≦x≦⅔, 0≦y≦⅔, and M¹ and M² are each independently at least one selected from the group consisting of Ni, Co, Mn, Fe, and Al). The positive electrode is low-cost and is excellent in reversibility of structural change with charge and discharge, and thus the molten salt battery having excellent cycle characteristics can be produced.

In a preferred form, the separator is made of glass fibers. The glass fibers easily absorb moisture and thus generally easily cause the introduction of moisture in the molten salt battery. On the other hand, this possibility is removed when the separator is incorporated into the battery after the moisture content Ws in the separator is controlled to 350 ppm or less in terms of mass ratio. In addition, heat resistance of the separator is significantly enhanced by forming the separator using glass fibers, and thus the molten salt battery more suitable for long-term use at a high temperature can be produced.

The separator made of the glass fibers preferably has a thickness of 20 μm to 500 μm. This can more effectively suppress internal short-circuiting and brings the volume of the separator occupying the battery into a range advantageous for producing a high-capacity battery. Therefore, the battery having high reliability and high capacity can be produced. In addition, in the molten salt battery, a compression load applied in the thickness direction of the separator made of glass fibers is preferably 0.1 MPa to 1 MPa. This can more effectively suppress internal short-circuiting.

In another preferred form, the separator is made of a silica-containing polyolefin. Silica easily absorbs moisture and thus generally easily causes the introduction of moisture in the molten salt battery. On the other hand, this possibility is removed when the separator is incorporated into the battery after the moisture content Ws in the separator is controlled to 350 ppm or less in terms of mass ratio. In addition, heat resistance of the separator is significantly enhanced by forming the separator using a silica-containing polyolefin.

The separator made of the silica-containing polyolefin preferably has a thickness of 10 μm to 500 μm. This can more effectively suppress internal short-circuiting and brings the volume of the separator occupying the battery into a range advantageous for producing a high-capacity battery. In addition, in the molten salt battery, a compression load applied in the thickness direction of the separator made of the silica-containing polyolefin is preferably 0.1 MPa to 14 MPa. This can more effectively suppress internal short-circuiting and can decrease internal resistance.

In a further preferred form, the separator is made of a fluororesin or polyphenylene sulfite (PPS). The fluororesin and PPS have high heat resistance and absorb little moisture, and thus the moisture content Ws in the separator can be decreased to 350 ppm or less by drying at a high temperature for a short time. Therefore, this is advantageous for decreasing the moisture content in the molten salt battery.

The separator made of the fluororesin or PPS preferably has a thickness of 10 μm to 500 μm. This can more effectively suppress internal short-circuiting and brings the volume of the separator occupying the battery into a range advantageous for producing a high-capacity battery.

Also, in the molten salt battery, a compression load applied in the thickness direction of the separator made of the fluororesin or PPS is preferably 0.1 MPa to 14 MPa. This can more effectively suppress internal short-circuiting and can decrease internal resistance.

The separator has many voids which can hold moisture and is interposed between the positive electrode and the negative electrode, and thus the importance of decreasing the moisture content is considered to be large. Therefore, in the production method described above, in the step of preparing the separator, the separator is preferably dried at a drying temperature of 90° C. or more in a reduced-pressure environment of 10 Pa or less. As a result, the moisture content Ws in the separator can be decreased to 350 ppm or less in terms of mass ratio within a relatively short time. Although the upper limit of the drying temperature changes with the material of the separator, the higher the temperature is, the more the time required for drying can be shortened. In addition, the positive electrode and the negative electrode are also preferably dried at a drying temperature of 90° C. or more and in a reduced-pressure environment of 10 Pa or less.

On the other hand, in the step of preparing the molten salt, it is preferred that a solid alkali metal is immersed in the molten salt in a molten state in an atmosphere of a dew point temperature of −50° C. or less and the molten salt in the molten state is stirred at a temperature of less than the melting point of the alkali metal. As a result, the moisture content We2 in the molten salt can be easily decreased to 50 ppm or less and further decreased to 20 ppm or less in terms of mass ratio within a relatively short time.

### Advantageous Effects of Invention

According to the present invention, the moisture content in each of the components of a battery is properly controlled, thereby suppressing the formation of sodium oxide due to reaction of sodium with moisture and the precipitation of dendrites from the sodium oxide as a starting point. Also, the moisture content We1 in a molten salt interposed between a positive electrode and a negative electrode is controlled to 300 ppm or less, and thus the growth of dendrites along fine pores (that is, the migration path of sodium ions) in a separator can be effectively suppressed. Therefore, short-circuiting between the positive electrode and the negative electrode can be suppressed, and excellent cycle characteristics can be achieved.

### BRIEF DESCRIPTION OF DRAWINGS

FIG. 1 is a front view of a positive electrode according to an embodiment of the present invention.

FIG. 2 is a cross-sectional view taken along line II-II in FIG. 1.

FIG. 3 is a front view of a negative electrode according to an embodiment of the present invention.

FIG. 4 is a cross-sectional view taken along line IV-IV in FIG. 3.

FIG. 5 is a partially cut-away perspective view of a battery case of a molten salt battery according to an embodiment of the present invention.

FIG. 6 is a schematic longitudinal cross-sectional view taken along line VI-VI in FIG. 5.

FIG. 7 is a graph showing a charge-discharge curve of a molten salt battery of Example 1.

FIG. 8 is a graph showing a charge-discharge curve of a molten salt battery of Comparative Example 1.

### DESCRIPTION OF EMBODIMENTS

The present invention relates to a molten salt battery including a positive electrode, a negative electrode, a separator interposed between the positive electrode and the negative electrode, and an electrolyte, the electrolyte including a molten salt, and the molten salt containing at least sodium ions. However, the moisture content We1 in the molten salt is decreased to 300 ppm or less in terms of mass ratio. The electrolyte can contain various additives in addition to the molten salt, but the electrolyte preferably includes only the molten salt from the viewpoint of securing ionic conductivity and thermal stability. Even when the electrolyte contains additives, the electrolyte preferably includes 90% by mass or more and more preferably 95% by mass or more of the molten salt.

As described above, reaction of sodium ions, which are carriers taking a role in ion conduction of the molten salt battery, with moisture is suppressed by controlling the moisture content in the battery. As a result, the formation of sodium oxide and the precipitation of dendrites of sodium metal from the sodium oxide as a starting point are suppressed, and the occurrence of internal short-circuiting and decrease in cycle characteristics are decreased. Also, the degree of precipitation of dendrites greatly depends on, particularly, the moisture content in the migration path of sodium ions between the positive electrode and the negative electrode. The separator is interposed between the positive electrode and the negative electrode, and the molten salt is impregnated into the voids of the separator. Of the moisture (moisture which can be detected by a Karl Fischer method) contained in the positive electrode, the negative electrode, and the separator, most of movable moisture is considered to move to the molten salt in the battery. Therefore, it is important to strictly control the moisture content We1 in the molten salt of the molten salt battery, and specifically it is necessary to decrease the moisture content We1 to 300 ppm or less in terms of mass ratio. When the moisture content We1 in the molten salt of the molten salt battery exceeds 300 ppm, it is difficult to suppress the occurrence of internal short-circuiting and decrease in cycle characteristics.

The moisture content We1 in the molten salt of the molten salt battery is preferably decreased to 200 ppm or less in terms of mass ratio. This increases the effect of suppressing the precipitation of dendrites regardless of the type of the negative electrode material and further prevents the occurrence of internal short-circuiting. Also, the effect of improving cycle characteristics is increased.

The molten salt preferably includes at least one selected from the group consisting of compounds represented by N(SO₂X¹)(SO₂X²)·M (wherein X¹ and X² are each independently a fluorine atom or a fluoroalkyl group having 1 to 8 carbon atoms, and M is an alkali metal or an organic cation having a nitrogen-containing hetero-ring). In this case, the molten salt contains at least N(SO₂X¹)(SO₂X²)·Na. The molten salt has a relatively low melting point and excellent thermal stability, and is advantageous in that moisture content can be easily controlled by a method described below.

From the viewpoint of producing the molten salt battery with a higher capacity, the negative electrode including a metallic material for an active material layer is preferably used. For example, an alkali metal such as sodium may be used for the active material layer, or a metal which is alloyed with an alkali metal may be used for the active material layer.

A preferred form of the negative electrode includes, for example, a negative electrode current collector composed of a first metal, and a second metal which covers at least a portion (preferably 80% or more of the surface of the negative electrode current collector) of the surface of the negative electrode current collector. The first metals is a metal which is not alloyed with sodium. The second metal is a metal which is alloyed with sodium and functions as a negative electrode active material layer. The negative electrode current collector composed of the first metal which is not alloyed with sodium can maintain strength over a long period of time. Also, by using the second metal which is alloyed with sodium for the negative electrode active material layer, the precipitation of dendrites is easily suppressed even when the battery reaction to precipitate sodium on the negative electrode proceeds.

Examples of a material of the separator include, but are not particularly limited to, glass fibers, silica-containing polyolefins, fluororesins, polyphenylene sulfite (PPS), ceramic materials (for example, alumina particles), and the like. The moisture content in any one of these materials can be controlled by a relatively simple method such as heating.

The separator made of the glass fibers preferably has a thickness of 20 μm to 500 μm. This is because with this thickness, the capacity of the molten salt battery can be maintained relatively high, and internal short-circuiting little occurs. In addition, in the molten salt battery, a compression load applied in the thickness direction of the separator made of glass fibers is preferably 0.1 MPa to 1 MPa. This is considered to be because when the compression load is applied, the resistance between the positive electrode and the negative electrode is properly controlled, and no internal short-circuiting occurs.

From the same viewpoint, the separator made of the silica-containing polyolefin preferably has a thickness of 10 μm to 500 μm, and in the molten salt battery, a compression load applied in the thickness direction of the separator made of the silica-containing polyolefin is preferably 0.1 MPa to 14 MPa. Further, the separator made of the fluororesin or PPS preferably has a thickness of 10 μm to 500 μm, and in the molten salt battery, a compression load applied in the thickness direction of the separator made of the fluororesin or PPS is preferably 0.1 MPa to 14 MPa.

The molten salt battery of the present invention can be produced by a production method including a step of preparing the positive electrode having a moisture content Wp of 300 ppm or less in terms of mass ratio, a step of preparing the negative electrode having a moisture content Wn of 400 ppm or less in terms of mass ratio, a step of preparing, as the electrolyte, the molten salt having a moisture content We2 of 50 ppm or less in terms of mass ratio and containing at least sodium ions, a step of preparing the separator having a moisture content Ws of 350 ppm or less in terms of mass ratio, and a step of stacking the positive electrode and the negative electrode with thee separator interposed therebetween to form an electrode group. The electrode group is housed in a battery case together with the molten salt, thereby completing the molten salt battery.

As described above, each of the moisture content in the positive electrode, the negative electrode, the molten salt, and the separator is individually controlled, thereby facilitating the management for limiting the whole moisture content in the molten salt battery. However, for example, the moisture content in each of the components may be controlled within the range described above by forming the electrode group including the positive electrode, the negative electrode, and the separator, and then performing a treatment of decreasing the moisture content of the electrode group.

The step of preparing the separator having the moisture content within the range described above includes, for example, drying the separator at a drying temperature of 90° C. or more (more preferably 90° C. to 300° C.) in a reduced-pressure environment of 10 Pa or less, preferably 1 Pa or less, and more preferably 0.4 Pa or less. This method is simple and advantageous in that the production cost is not increased. The air in a treatment atmosphere is previously replaced by inert gas (for example, nitrogen, helium, or argon) or dry air with a dew point temperature of −50° C. or less before the reduced-pressure environment is established as the treatment atmosphere, and consequently, moisture can be effectively removed from the separator.

More specifically, when the separator is made of the glass fibers, the separator is preferably dried under reduced pressure at 100° C. to 300° C. for 2 hours to 24 hours. The pressure of the drying atmosphere is preferably controlled to 10 Pa or less and more preferably 1 Pa or less.

In addition, when the separator includes a silica-containing separator, the separator is preferably dried under reduced pressure at 90° C. to 120° C. for 2 hours to 24 hours. In this case also, the pressure of the drying atmosphere is preferably controlled to 10 Pa or less and more preferably 1 Pa or less.

Further, when the separator is made of the fluororesin, such as polytetrafluoroethylene (PTFE), or PPS, the separator is preferably dried under reduced pressure at 100° C. to 260° C. for 2 hours to 24 hours. In this case also, the pressure of the drying atmosphere is preferably controlled to 10 Pa or less and more preferably 1 Pa or less.

Also, the drying step for decreasing the moisture content in each of the positive electrode and the negative electrode can be performed under the same conditions as described above. More specifically, each of the positive electrode and the negative electrode is preferably dried under reduced pressure at 90° C. to 200° C. for 2 hours to 24 hours. The pressure of the drying atmosphere is preferably controlled to 10 Pa or less and more preferably 1 Pa or less.

The step of preparing the molten salt having the moisture content We2 in the range described above includes, for example, immersing a solid alkali metal in the molten salt in a molten state in an atmosphere (for example, an inert gas atmosphere of nitrogen, helium, or argon or in air) at a dew point temperature of −50° C. or less, and stirring the molten salt in the molten state at a temperature of less than the melting point of the alkali metal. This method is to remove moisture by chemical reaction of the solid alkali metal with moisture in the molten salt. This method decreases the moisture content to a very low level because the reaction of the alkali metal with moisture in the molten salt rapidly proceeds. For example, the moisture content We2 is easily decreased to 20 ppm or less in terms of mass ratio. Also, the solid alkali metal can be easily recovered from the stirred mixture, and thus the method is advantageous in that the production cost is not increased.

The temperature of stirring of the solid alkali metal and the molten salt in the molten state is preferably, for example, 60° C. to 90° C., depending on the type of the alkali metal. Lithium, sodium, cesium, or the like can be used as the alkali metal, and sodium is inexpensive and suitable for removing the moisture in the molten metal.

In this case, the positive electrode contains, as the positive electrode active material, a material which electrochemically reacts with sodium ions, and the negative electrode contains, as the negative electrode active material, a material which electrochemically reacts with sodium ions. The electrochemical reaction may be a reaction to dissolve or precipitate sodium, a reaction to release or store sodium ions from or in a predetermined material, a reaction to separate or adsorb sodium ions from or on a predetermined material, or another type of reaction.

The separator has the function to physically separate between the positive electrode and the negative electrode and the function to secure the migration path of sodium ions moving between the positive electrode and the negative electrode. Besides the materials described above, various porous sheets can be used for the separator.

The molten salt is a salt containing at least sodium ions as a cation and an organic or inorganic anion as an anion. The molten salt is impregnated into the voids of the electrode group constituted by the positive electrode, the negative electrode, and the separator interposed therebetween, and functions in a molten state as the electrolyte. That is, the electrolyte of the molten salt battery is mostly composed of an ionic substance (also referred to as an “ionic liquid” at a temperature equal to or higher than the melting point). The melting point of the molten salt may be selected according to application of the molten salt battery.

Any one of the moisture content Wp in the positive electrode, the moisture Wn in the negative electrode, the moisture content We in the molten salt, and the moisture content Ws in the separator is a moisture content measured by the Karl Fischer method. The moisture content in each of the positive electrode and the negative electrode is a total moisture content in the current collector and the active material layer. Specifically, at least one sample selected from the positive electrode, the negative electrode, the molten salt, and the separator is paced together with a catholyte in a cell of a moisture content measuring apparatus, and moisture is measured.

The catholyte contains alcohol, a base, sulfur dioxide, or iodide ions. The Karl Fischer method is classified into a capacity titration method and a coulometric titration method, but the coulometric titration method with high analytical precision is used. In addition, a commercial Karl Fischer moisture titrator (for example, “MKC-610” manufactured by Kyoto Electronics Manufacturing Co., Ltd.) can be used as the moisture content measuring apparatus.

The moisture content of each of the components is measured by placing a sample in a cell of a moisture content measuring apparatus filled with a fresh catholyte in a nitrogen atmosphere. For the sample of the positive electrode, the negative electrode, or the separator, the weight of the sample may be within a range of 0.05 g to 5 g. For the sample of the molten salt, the weight of the sample may be within a range of 0.05 g to 3 g. The moisture content in the molten salt can be measured at a temperature equal to higher than the melting point or less than the melting point.

The moisture content We1 in the molten salt of the battery may be measured by disassembling the battery and taking out the molten salt and measuring the moisture content of the molten salt or taking out the separator impregnated with the molten salt and measuring the moisture content of the separator. When the moisture content in the separator impregnated with the molten salt is measured, the moisture content in the separator may be converted into the moisture content in the molten salt by using the weight of the separator and the weight of the molten salt contained in the sample.

Next, each of the components is specifically described based on an example of the molten salt battery.

### [Positive Electrode]

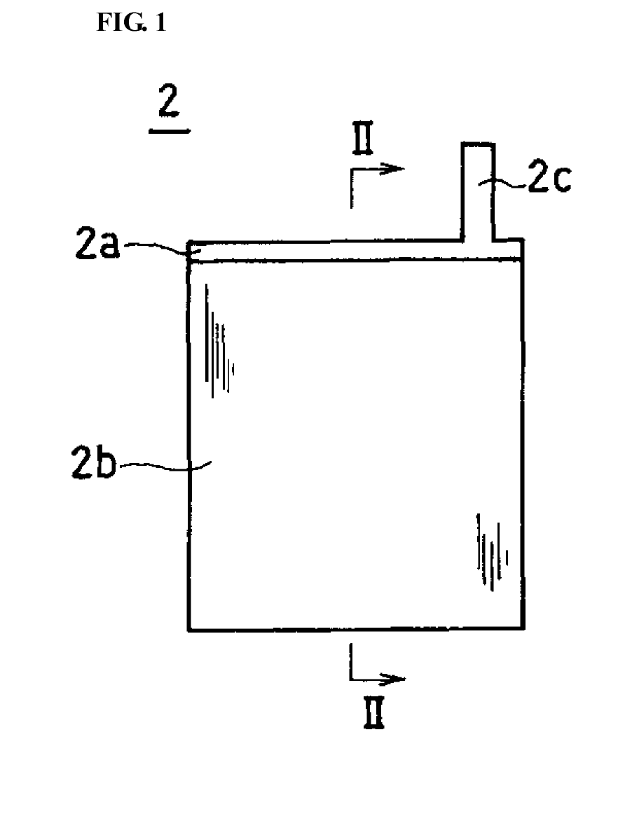

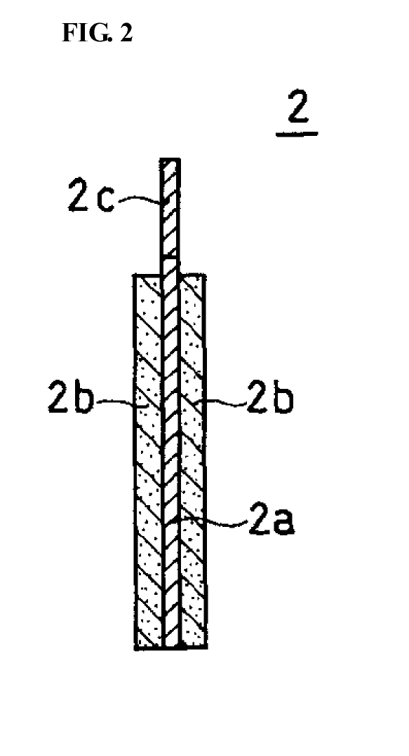

FIG. 1 is a front view of a positive electrode according to an embodiment of the present invention, and FIG. 2 is a cross-sectional view taken along line II-II in FIG. 1.

A positive electrode 2 includes a positive electrode current collector 2a and a positive electrode active material layer 2b fixed on the positive electrode current collector 2a. The positive electrode active material layer 2b contains a positive electrode active material as an essential component and may further contain a binder, a conductive agent, and the like as optional components.

A metal foil, a nonwoven fabric made of metal fibers, a metal porous sheet, or the like can be used as the positive electrode current collector 2a. A metal constituting the positive electrode current collector is preferably aluminum or an aluminum alloy because of its stability at a positive electrode potentialo but is not particularly limited. The thickness of the metal foil serving as the positive electrode current collector is, for example, 10 μm to 50 μm, and the thickness of the metal fiber nonwoven fabric or metal porous sheet is, for example, 100 μm to 600 μm. In addition, a lead piece 2c for current collection may be formed on the positive electrode current collector 2a. The lead piece 2c may be formed integrally with the positive electrode current collector as shown in FIG. 1 or the lead piece separately formed may be connected to the positive electrode current collector by welding or the like.

From the viewpoint of thermal stability and electrochemical stability, a sodium-containing transition metal compound is preferably used as the positive electrode active material. A compound having a layered structure which permits going in and out of sodium between layers is preferred used as the sodium-containing transition metal compound but is not particularly limited.

For example, the sodium-containing transition metal compound is preferably at least one selected from the group consisting of sodium chromite (NaCrO₂) and sodium iron-manganese oxide (Na_{2/3}Fe_{1/3}Mn_{2/3}O₂). Also, Cr or Na of sodium chromite may be partially substituted by another element, and Fe, Mn, or Na of sodium iron-manganese oxide may be partially substituted by another element. Examples of the compound which can be used include Na₁₋ₓM¹ₓCr_{1-y}M²_{y}O₂ (0≦x≦⅔, 0≦y≦⅔, and M¹ and M² are each independently a metal element other than Cr and Na, for example, at least one selected from the group consisting of Ni, Co, Mn, Fe, and Al), and Na_{2/3-x}M³ₓFe_{1/3-y}Mn_{2/3-z}M⁴_{y+z}O₂ (0≦x≦⅓, 0≦y≦⅓, 0≦z≦⅓, and M³ and M⁴ are each independently a metal element other than Fe, Mn, and Na, for example, at least one selected from the group consisting of Ni, Co, Al, and Cr). Other examples which can be used include NaMnF₃, Na₂FePO₄F, NaVPO₄F, NaCoPO₄, NaNiPO₄, NaMnPO₄, NaMn_{1.5}Ni₀₅O₄, NaMn_{0.5}Ni_{0.5}O₂, TiS₂, FeF₃, and the like. The positive electrode active material may be used singly or a combination of a plurality of types may be use. In addition, M¹ and M³ are each an element occupying a Na site, M² is an element occupying a Cr site, and M⁴ is an element occupying a Fe or Mn site.

The binder plays the function of bonding the positive electrode active material and fixing the positive electrode active material to the positive electrode current collector. Examples of the binder which can be used include fluororesins, polyamide, polyimide, polyamide-imide, and the like. Examples of the fluororesins which can be used include polyvinylidene fluoride, polytetrafluoroethylene, tetrafluoroethylene-hexafluoropropylene copolymers, vinylidene fluoride-hexafluoropropylene copolymers, and the like. The amount of the binder is preferably 1 part by mass to 10 parts by mass and more preferably 3 parts by mass to 5 parts by mass based on 100 parts by mass of the positive electrode active material.

Examples of the conductive agent contained in the positive electrode include graphite, carbon black, carbon fibers, and the like. Among these, carbon black is particularly preferred because a conductive path can be easily formed by using a small amount. Examples of the carbon black include acethylene black, ketjen black, thermal black, and the like. The amount of the conductive agent is preferably 5 parts by mass to 15 parts by mass and more preferably 5 parts by mass to 10 parts by mass based on 100 parts by mass of the positive electrode active material.

### [Negative Electrode]

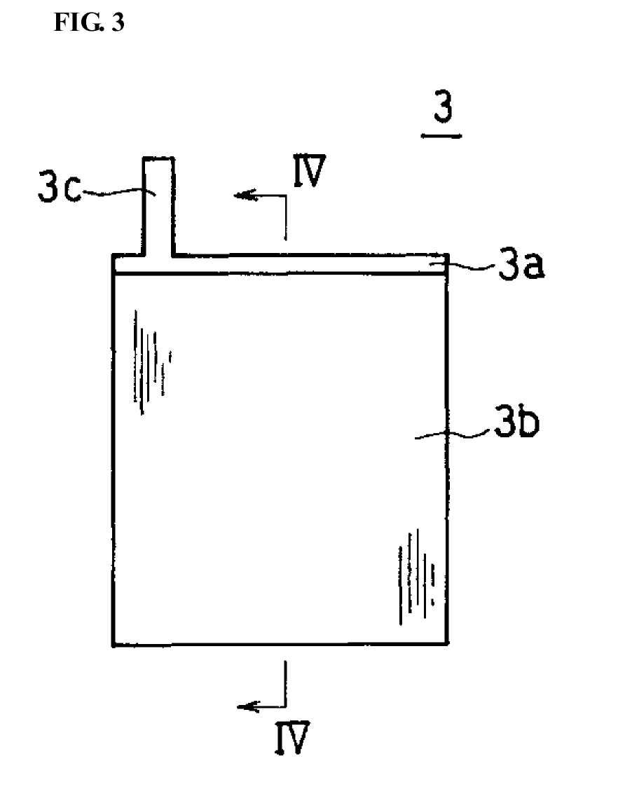

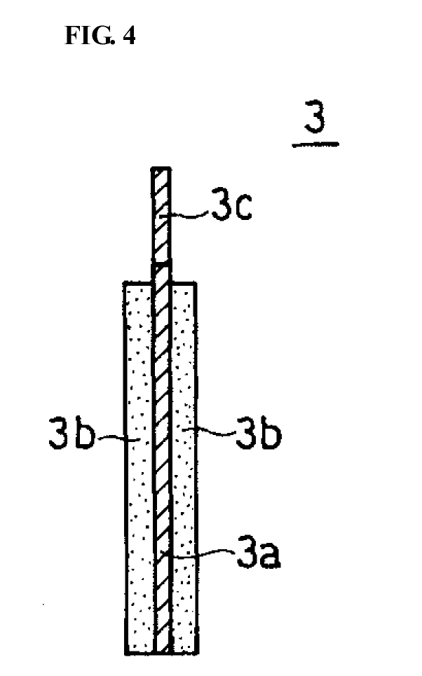

FIG. 3 is a front view of a negative electrode according to an embodiment of the present invention, and FIG. 4 is a cross-sectional view taken along line IV-IV in FIG. 3.

A negative electrode 3 includes a negative electrode current collector 3a and a negative electrode active material layer 3b fixed on the negative electrode current collector 3a. For example, sodium, a sodium alloy, or a metal which can be alloyed with sodium can be used for the negative electrode active material layer 3b. The negative electrode active material layer 3b includes the negative electrode current collector composed of a first metal and a second metal which covers at least a portion of the surface of the negative electrode current collector.

In this case, the first metal is a metal which is not alloyed with sodium, and the second metal which is alloyed with sodium.

A metal foil, a nonwoven fabric made of glass fibers, or a metal porous sheet can be used as the negative electrode current collector composed of the first metal. The first metal is preferably aluminum, an aluminum alloy, copper, a copper alloy, nickel, a nickel alloy, or the like because such a metal is not alloyed with sodium and is stable at a negative electrode potential. Among these, aluminum and an aluminum alloy are preferred in view of excellent lightness of weight. In addition, the amount of a metal component (for example, Fe, Si, Ni, Mn, or the like) other than aluminum in an aluminum alloy is preferably 0.5% by mass or less. The thickness of the metal foil serving as the negative electrode current collector is, for example, 10 μm to 50 μm, and the thickness of the metal fiber nonwoven fabric or metal porous sheet is, for example, 100 μm to 600 μm. In addition, a lead piece 3c for current collection may be formed on the negative electrode current collector 3a. The lead piece 3c may be formed integrally with the negative electrode current collector as shown in FIG. 3 or the lead piece separately formed may be connected to the negative electrode current collector by welding or the like.

Examples of the second metal include zinc, a zinc alloy, tin, a tin alloy, silicon, a silicon alloy, and the like. Among these, zinc and a zinc alloy are preferred in view of good wettability with the molten salt. The thickness of the negative electrode active material layer composed of the second metal is, for example, 0.05 μm to 1 μm. In addition, the amount of a metal component (for example, Fe, Ni, Si, Mn, or the like) other than zinc or tin in a zinc alloy or tin alloy is preferably 0.5% by mass or less.

An example of a preferred form of the negative electrode include a negative electrode current collector composed of aluminum or an aluminum alloy (the first metal) and zinc, a zinc alloy, tin, or a tin alloy (the second metal) which covers at least a portion of the surface of the negative electrode current collector. This negative electrode has a high capacity, little deteriorates over a long period of time, and exhibits the larger effect of suppressing the precipitation of dendrites by controlling the moisture content in the battery.

The negative electrode active material layer composed of the second metal can be produced by, for example, attaching or pressure-bonding a sheet of the second metal to the negative electrode current collector. Also, the second metal may be gasified and adhered to the negative electrode current collector by a vapor phase method such as a vacuum deposition method, a sputtering method, or the like, or fine particles of the second metal may be adhered by an electrochemical method such as a plating method or the like. The thin and uniform negative electrode active material layer can be formed by the vapor phase method or the plating method.

The negative electrode active material layer 3b contains a negative electrode active material as an essential component and may further contain a binder, a conductive agent, and the like as optional components. The same examples of materials described for the constituent components of the positive electrode can be used for the binder and the conductive agent used in the negative electrode. The amount of the binder is preferably 1 part by mass to 10 parts by mass and more preferably 3 parts by mass to 5 parts by mass based on 100 parts by mass of the negative electrode active material. The amount of the conductive agent is preferably 5 parts by mass to 15 parts by mass and more preferably 5 parts by mass to 10 parts by mass based on 100 parts by mass of the negative electrode active material.

From the viewpoint of thermal stability and electrochemical stability, a sodium-containing titanium compound, hardly graphitizable carbon (hard carbon), or the like is preferably used as the negative electrode active material constituting the negative electrode active material layer. The sodium-containing titanium compound is preferably sodium titanate and, more specifically, at least one selected from the group consisting of Na₂Ti₃O₇ and Na₄Ti₅O₁₂ is preferably used. Also, Ti or Na of sodium titanate may be partially substituted by another element. Examples of the compound which can be used include Na₂₋ₓM⁵ₓTi_{3-y}M⁶_{y}O₇ (0≦x≦3/2, 0≦y≦8/3, and M⁵ and M⁶ are each independently a metal element other than Ti and Na, for example, at least one selected from the group consisting of Ni, Co, Mn, Fe, Al, and Cr), and Na₄₋ₓM⁷ₓTi_{5-y}M⁸_{y}O₁₂ (0≦x≦11/3, 0≦y≦14/3, and M⁷ and M⁸ are each independently a metal element other than Ti and Na, for example, at least one selected from the group consisting of Ni, Co, Mn, Fe, Al, and Cr). The sodium-containing titanium compound may be used singly or a combination of a plurality of types may be used. The sodium-containing titanium compound may be combined with hardly graphitizable carbon. In addition, M⁵ and M⁷ are each an element occupying a Na site, and M⁶ and M⁸ are each an element occupying a Ti site.

The hardly graphitizable carbon is a carbon material which does not develop a graphite structure even by heating in an inert atmosphere and represents a material containing fine graphite crystals arranged in random directions and having nano-order voids between crystal layers. Since the diameter of sodium ions which is a typical alkali metal is 0.95 angstroms, the size of the voids is preferably sufficiently larger than this diameter. The average particle diameter of the hardly graphitizable carbon (particle diameter at 50% cumulative volume in a volume particle size distribution) may be, for example, 3 μm to 20 μm, and is preferably 5 μm to 15 μm from the viewpoint of enhancing the filling property of the negative electrode active material in the negative electrode and suppressing side reaction with the electrolyte. The specific surface area of the hardly graphitizable carbon may be, for example, 1 m²/g to 10 m²/g and is preferably 3 m²/g to 8 m²/g from the viewpoint of securing sodium ion acceptability and suppressing side reaction with the electrolyte. The hardly graphitizable carbon may be used singly or a combination of a plurality of types may be used.

### [Electrolyte (Molten Salt)]

A salt which becomes an ionic liquid at a temperature equal to or higher than the melting point is used as the electrolyte (molten salt). The electrolyte contains at least a salt containing, as a cation, sodium ions which serve as charge carriers in the molten salt battery. Examples of the salt which can be used include compounds represented by N(SO₂X¹)(SO₂X²)·M (wherein X¹ and X² are each independently a fluorine atom or a fluoroalkyl group having 1 to 8 carbon atoms, and M is an alkali metal or an organic cation having a nitrogen-containing hetero-ring). The N(SO₂X¹)(SO₂X²)·M includes at least N(SO₂X¹)(SO₂X²)·Na.

A fluoroalkyl group represented by X¹ and X² may be an alkyl group in which some of the hydrogen atoms are substituted by fluorine atoms or may be a perfluoroalkyl group in which all of the hydrogen atoms are substituted by fluorine atoms. From the viewpoint of decreasing the viscosity of an ionic liquid, at least one of X¹ and X² is preferably a perfluoroalkyl group, and both of X¹ and X² are more preferably perfluoroalkyl groups. Having 1 to 8 carbon atoms can suppress an increase in the melting point of the electrolyte and is thus advantageous for forming a low-viscosity ionic liquid. In particular, from the viewpoint of producing a low-viscosity ionic liquid, the perfluoroalkyl group preferably has 1 to 3 carbon atoms and more preferably 1 or 2 carbon atoms. Specifically, X¹ and X² may be each independently a trifluoromethyl group, a pentafluoroethyl group, a heptafluoropropyl group, or the like.

Specific examples of bissulfonylamide anion represented by N(SO₂X¹)(SO₂X²) include bis(fluorosulfonyl) amide anion (FSA), bis(trifluoromethylsulfonyl) amide anion (TFSA⁻), bis(pentafluoroethylsulfonyl) amide anion, fluorosulfonyl trifluoromethylsulfonylamide anion (N(FSO₂)(CF₃SO₂)), and the like.

Examples of an alkali metal other than sodium represented by M include potassium, lithium, rubidium, and cesium. Among these, potassium is preferred.

A cation having a pyrrolidinium skeleton, an imidazolium skeleton, a pyridinium skeleton, a piperidinium skeleton, or the like can be used as an organic cation having a nitrogen-containing hetero-ring represented by M. In particular, a cation having a pyrrolidinium skeleton is preferred in view of the point that it can form a molten salt having a low melting point and is also stable at a high temperature.

The organic cation having a pyrrolidinium skeleton is represented by, for example, a general formula (1):

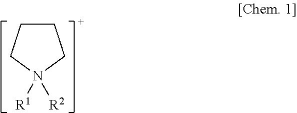

wherein R¹ and R² are each independently an alkyl group having 1 to 8 carbon atoms. Having 1 to 8 carbon atoms can suppress an increase in the melting point of the electrolyte and is thus advantageous for forming a low-viscosity ionic liquid. In particular, from the viewpoint of producing a low-viscosity ionic liquid, the alkyl group preferably has 1 to 3 carbon atoms and more preferably 1 or 2 carbon atoms. Specifically, R¹ and R² may be each independently a methyl group, an ethyl group, a propyl group, an isopropyl group, or the like.

Specific examples of the organic cation having a pyrrolidinium skeleton include methylpropylpyrrolidinium cation, ethylpropylpyrrolidinium cation, methylethylpyrrolidinium cation, dimethylpyrrolidinium cation, diethylpyrrolidinium cation, and the like. These may be used alone or in combination of plural types. Among these, methylpropylpyrrolidinium cation (Py13⁺) is particularly preferred in view of high thermal stability and electrochemical stability.

Specific examples of the molten salt include a salt of sodium ion and FSA⁻ (NaFSA), a salt of sodium ion and TFSA⁻ (NaTFSA), a salt of Py13⁺ and FSA⁻ (Py13FSA), a salt of Py13⁺ and TFSA⁻ (Py13TFSA), and the like.

The molten salt preferably has as a low temperature as possible. From the viewpoint of decreasing the melting point of the molten salt, a mixture of two or more salts is preferably used. For example, when a first salt of sodium with bissulfonylamide anion is used, a second salt of cation other than sodium with bissulfonylamide anion is preferably used in combination with the first salt. The bissulfonylamide anions forming the first salt and the second salt may be the same or different.

Examples of the cation other than sodium which can be used include potassium ion, cesium ion, lithium ion, magnesium ion, calcium ion, the organic cations described above, and the like. These other cations may be used alone or in combination of two or more.

When NaFSA, NaTFSA, or the like is used as the first salt, a salt of potassium ion with FSA (KFSA), a salt of potassium with TFSA⁻ (KTFSA), or the like is preferably used as the second salt. More specifically, a mixture of NaFSA and KFSA or a mixture of NaTFSA and KTFSA is preferably used. In this case, the molar ratio (first salt/second salt) of the first salt to the second salt is, for example, 40/60 to 70/30, preferably 45/55 to 65/35, and more preferably 50/50 to 60/40 in view of the melting point of the electrolyte and balance between viscosity and ionic conductivity.

When a salt of Py13 is used as the first salt, the salt has a low melting point and has low viscosity even at room temperature. However, by using a sodium salt, a potassium salt, or the like as the second salt in combination with the first salt, the melting point is further decreased. When Py13FSA, Py13TFSA, or the like is used as the first salt, NaFSA, NaTFSA, or the like is preferably used as the second salt. More specifically, a mixture of Py13FSA and NaFSA or a mixture of Py13TFSA and NaTFSA is preferably used. In this case, the molar ratio (first salt/second salt) of the first salt to the second salt is, for example, 97/3 to 80/20 and preferably 95/5 to 85/15 in view of the melting point of the electrolyte and balance between viscosity and ionic conductivity.

Besides the salts described above, the electrolyte can contain various additives. However, from the viewpoint of securing ionic conductivity and thermal stability, the molten salt preferably occupies the electrolyte at a ratio of 90% by mass to 100% by mass and more preferably 95% by mass to 100% by mass of the electrolyte filled in the battery.

### [Separator]

The material of the separator may be selected in view of the operating temperature of the battery, but glass fibers, a silica-containing polyolefin, a fluororesin, alumina, polyphenylene sulfite (PPS), or the like is preferably used from the viewpoint of suppressing side reaction with the electrolyte. In particular, a glass fiber nonwoven fabric is preferred in view of its inexpensiveness and high heat resistance. Also, a silica-containing polyolefin and alumina are preferred in view of excellent heat resistance. Further, a fluororesin and PPS are preferred in view of heat resistance and corrosion resistance. In particular, PP is excellent in resistance to fluorine contained in the molten salt.

The silica-containing polyolefin represents a polyolefin kneaded with a silica powder in order to improve thermal stability, and the separator having a porous structure can be produced by forming a sheet of the polyolefin and then uniaxially or biaxially stretching the sheet. It is preferred to use at least one selected from polyethylene and polypropylene as the polyolefin.

In view of excellent heat resistance, polytetrafluoroethylene (PTFE) is particularly preferred as the fluororesin. The separator made of the fluororesin or PPS may include a nonwoven fabric made of fluororesin fibers or PPS fibers or a film having a porous structure formed through a stretching process. In particular, a nonwoven fabric is preferred in view of high porosity and no inhibition to ionic conductivity.

Some specific preferred configurations of the separator are described below.

The thickness of the separator made of glass fibers is 20 μm to 500 μm and more preferably 20 μm to 50 μm. This is because with the thickness within this range, internal short-circuiting can be effectively suppressed, and the volume fraction of the separator occupying the electrode group can be suppressed, and thus a high capacity density can be obtained. On the other hand, the separator made of glass fibers has a relatively large pore diameter and high porosity. Therefore, from the viewpoint of effectively preventing internal short-circuiting, a compression load applied in the thickness direction of the separator is preferably relatively low and is preferably 0.1 MPa to 1 MPa.

The thickness of the separator made of a silica-containing polyolefin is 10 μm to 500 μm and more preferably 20 μm to 50 μm. This is because the separator is preferably relatively thin because of the small pore diameter and low porosity as compared with the separator made of glass fibers. In addition, a compression load applied in the thickness direction of the separator made of a silica-containing polyolefin is preferably 0.1 MPa to 14 MPa and more preferably 0.1 MPa to 3 MPa. This is because by applying this compression load, the internal resistance can be decreased, and the occurrence of internal short-circuiting can be more effectively prevented.

The thickness of the separator made of PTFE is 10 μm to 500 μm and more preferably 20 μm to 50 μm. This is because the separator made of PTFE is preferably relatively thin because of the small pore diameter and low porosity. In addition, a compression load applied in the thickness direction of the separator made of PTFE is preferably 0.1 MPa to 14 MPa and more preferably 0.1 MPa to 5 MPa. This is because PTFE has high heat resistance and excellent mechanical strength, and thus even when a relatively high compression load is applied, the occurrence of internal short-circuiting can be effectively prevented.

The porosity of the separator can be derived from a pore size distribution measured by using a mercury porosimeter. The porosity can be calculated from the volume of a sample containing voids and the total volume of pores. The porosity may be, for example, in a range of 50% to 90%.

### [Electrode Group]

The molten salt battery is used in a state where the electrode group including the positive electrode and the negative electrode and the electrolyte are housed in a battery case. The electrode group is formed by stacking or winding the positive electrode and the negative electrode with the separator interposed therebetween. In this case, a battery case made of metal is used, and one of the positive electrode and the negative electrode is conducted to the battery case, so that a portion of the battery case can be used as a first external terminal. On the other hand, the other of the positive electrode and the negative electrode is connected to a second external terminal by using a lead piece, the second external terminal being led out from the battery case in a state of being insulated from the battery case.

Next, the structure of a molten salt battery according to an embodiment of the present invention is described with reference to the figures. However, the structure of the molten salt battery according to the present invention is not limited to the structure described below.

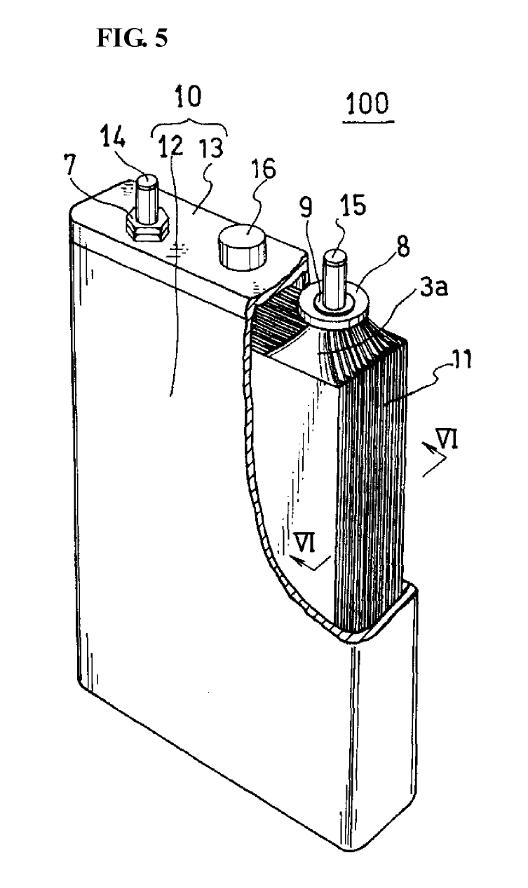

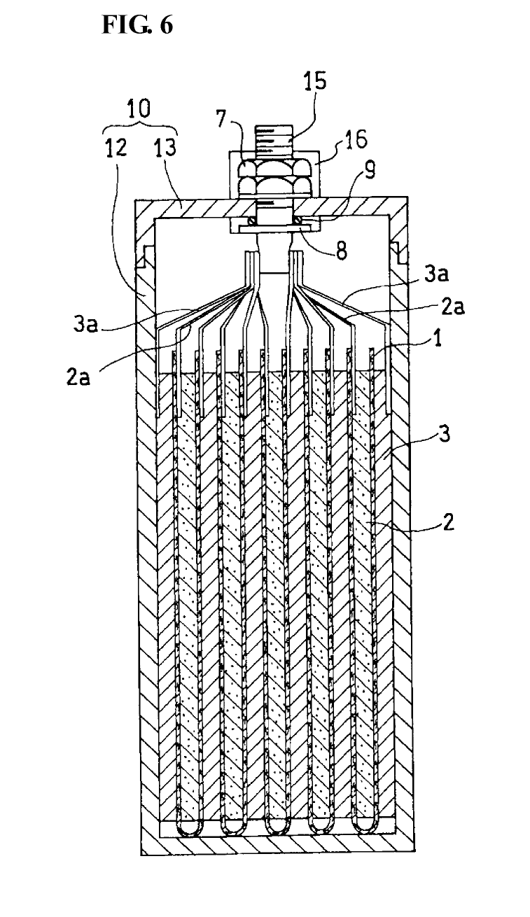

FIG. 5 is a perspective view of a molten salt battery in which a battery case is partially cut away, and FIG. 6 is a schematic longitudinal cross-sectional view taken along line VI-VI in FIG. 5.

A molten salt battery 100 is provided with a stacked-type electrode group 11, an electrolyte (not shown), and a square aluminum-made battery case 10 which houses these components. The battery case 10 includes a bottomed container body 12 having an open upper portion and a cover portion 13 which closes the open upper portion. In assembling the molten salt battery 100, first the electrode group 11 is formed and inserted in the container body 12 of the battery case 10. Then, there is performed the step of injecting the electrolyte in a molten state into the container body 12 and impregnating the electrolyte into voids of the separator 1, the positive electrode 2, and the negative electrode 3 which constitute the electrode group 11. Alternatively, the electrode group may be impregnated with the heated electrolyte in a molten state (ionic liquid), and then the electrode group containing the electrolyte may be housed in the container body 12.

An external positive electrode terminal 14 is provided near one of the sides of the cover portion 13 so as to pass through the cover portion 13 in a conductive state with the battery case 10, and an external negative electrode terminal 15 is provided near the other side of the cover portion 13 so as to pass through the cover portion 13 in an insulating state from the battery case 10. In addition, a safety valve 16 is provided at a center of the coper portion 13 in order to release the gas generated in the battery case 10 when the internal pressure is increased.

The stacked-type electrode group 11 includes a plurality of the positive electrodes 2, a plurality of the negative electrodes 3, and a plurality of the separators 1 each interposed between the positive electrode 2 and the negative electrode 3, any one of which has a rectangular sheet shape. In FIG. 6, the separator 1 is formed in a bag-like shape so as to surround the positive electrode 2, but the shape of the separator 1 is not particularly limited. A plurality of the positive electrodes 2 and a plurality of the negative electrodes 3 are alternately arranged in a stacking direction in the electrode group 11.

Further, a positive electrode lead piece 2a may be formed at one of the ends of each of the positive electrodes 2. The positive electrode lead pieces 2a of the plurality of the positive electrodes 2 are bundled and connected to the external positive electrode terminal 14 provided on the cover portion 13 of the battery case 10, and consequently the plurality of the positive electrodes 2 are connected in parallel. Similarly, a negative electrode lead piece 3a may be formed at one of the ends of each of the negative electrodes 3. The negative electrode lead pieces 3a of the plurality of the negative electrodes 3 are bundled and connected to the external negative electrode terminal 15 provided on the cover portion 13 of the battery case 10, and consequently the plurality of the negative electrodes 3 are connected in parallel. The bundle of the positive electrode lead pieces 2a and the bundle of the negative electrode lead pieces 3a are preferably disposed with a space therebetween on the right and the left of an end surface of the electrode group 11 so as to avoid contact therebetween.

Each of the external positive electrode terminal 14 and the external negative electrode terminal 15 has a columnar shape and has a screw groove provided in at least a portion exposed to the outside. A nut 7 is engaged with the screw groove of each of the terminals and the nut 7 is fixed to the cover portion 13 by rotating the nut 7. Further, a flange portion 8 is provided on each of the terminals in a portion housed in the battery case so that the flange portion 8 is fixed to the inner surface of the cover portion 13 through a washer 9 by rotating the nut 7.

Next, the present invention is more specifically described on the basis of examples. However, the present invention is not limited to the examples below.

### Example 1

### Formation of Positive Electrode

A positive electrode paste was prepared by dispersing 85 parts by mass of NaCrO₂ (positive electrode active material) having an average particle diameter of 10 μm, 10 parts by mass of acethylene black (conductive agent), and 5 parts by mass of polyvinylidene fluoride (binder) in N-methyl-2-pyrrolidone (NMP). The resultant positive electrode paste was applied to both surfaces of an aluminum foil having a thickness of 20 μm, sufficiently dried, and then rolled to form a positive electrode having a total thickness of 180 μm and a positive electrode compound layer having a thickness of 80 μm and formed on each of both surfaces thereof.

The positive electrode was cut into a rectangular shape with a size of 100 mm×100 mm, and 10 positive electrodes were prepared. In addition, a lead piece for current collection was formed at one of the side ends of one side of each of the positive electrodes. However, one of the 10 positive electrodes was an electrode having the positive electrode compound layer formed on one of the surfaces thereof.

### (Formation of Negative Electrode)

A zinc layer (second metal) having a thickness of 100 nm was formed on each of both surfaces of an aluminum foil (first metal) having a thickness of 10 μm by zinc plating, thereby forming a negative electrode having a total thickness of 10.2 μm.

The negative electrode was cut into a rectangular shape with a size of 105 mm×105 mm, and 10 negative electrodes were prepared. In addition, a lead piece for current collection was formed at one of the side ends of one side of each of the negative electrodes. However, one of the 10 negative electrodes was an electrode having a negative electrode active material layer formed on one of the surfaces thereof.

### (Separator)

A separator having a thickness of 50 μm and made of a silica-containing polyolefin was prepared. The average pore diameter was 0.1 μm, and the porosity was 70%. The separator was cut into a rectangular shape with a size of 110 mm×110 mm, and 21 separators were prepared.

### (Electrolyte)

A molten salt including a mixture of sodium bis(fluorosulfonyl) amide (NaFSA) and methylpropylpyrrolidinium bis(fluorosulfonyl) amide (Py13FSA) at a molar ratio of 1:9 was prepared. The molten salt had a melting point of −25° C.

### (Assembly of Molten Salt Battery)

First, the positive electrode, the negative electrode, and the separator were dried by heating at 90° C. or more under a reduced pressure of 0.3 Pa. Drying was performed until the moisture contents in the positive electrode and the negative electrode were 90 ppm and 45 ppm, respectively, and the moisture content in the separator was 45 ppm.

On the other hand, 10 parts by mass of solid sodium relative to 100 parts by mass of the molten salt was immersed in the molten salt in an atmosphere with a dew point temperature of −50° C. or less, followed by stirring at 90° C. As a result, the moisture content in the molten salt was decreased to 20 ppm.

Then, the positives electrodes and the negative electrodes were stacked with the separator interposed between each positive electrode and negative electrode so that the positive electrode lead pieces overlap each other, the negative electrode lead pieces overlap each other, and a bundle of the positive electrode lead pieces and a bundle of the negative electrode lead pieces are arranged at symmetrical positions, thereby forming an electrode group. The electrode having the active material layer (compound layer) formed on one of the surfaces thereof was disposed on each of the ends of the electrode group so that the active material layer facing the electrode had polarity different from that of the electrode. Then, the separator was also disposed on the outside of each of the ends of the electrode group, housed together with the molten salt in a battery case made of aluminum to complete a molten salt battery with a nominal capacity of 1.8 Ah having a structure as shown in FIGS. 5 and 6.

### (Measurement of Moisture Content)

The moisture content in each of the components was individually measured before the battery was assembled. In this example, the moisture content was measured by a Karl Fischer method (coulometric titration method) using a moisture content measuring apparatus (MKC-610 manufactured by Kyoto Electronics Manufacturing Co., Ltd.). The weight of each measurement sample was 3 g.

### [Evaluation (Charge-Discharge Cycle Test)]

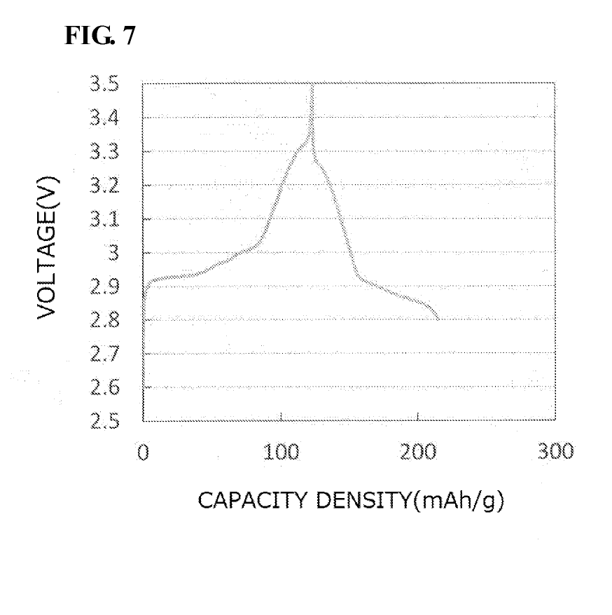

A plurality of molten salt batteries were formed, one of the batteries was disassembled immediately before a charge-discharge cycle test, the molten salt was taken out from the battery, and then moisture content We1 in the molten salt was measured. As a result, the moisture content We1 in the molten salt was 50 ppm. Next, another one of the batteries was maintained at 90° C. in a constant-temperature chamber, and constant-current charge and discharge were repeated at a current value of hour rate of 0.2C rate within a range of 2.5 V to 3.5 V. FIG. 7 shows a charge-discharge curve of the first cycle.

As a result, no internal short-circuiting was observed in the molten salt battery of this example even after 50 cycles, and thus good charge-discharge characteristics were obtained. In addition, the discharge capacity density per gram of the positive electrode active material at the 50th cycle was 118 mAh/g.

### Example 2

A molten salt battery was assembled and evaluated by the same methods as in Example 1 except that the moisture contents in the positive electrode, the negative electrode, and the molten salt were adjusted to 200 ppm, 350 ppm, and 50 ppm, respectively, and the moisture content in the separator was adjusted to 350 ppm. As a result, no internal short-circuiting was observed even after 50 cycles, and thus it was found that good charge-discharge characteristics are obtained. In addition, the discharge capacity density per gram of the positive electrode active material at the 50th cycle was 105 mAh/g. Also, the moisture content in the molten salt measured by disassembling one battery immediately before a charge-discharge cycle test and taking out the molten salt from the battery was 200 ppm.

### Comparative Example 1

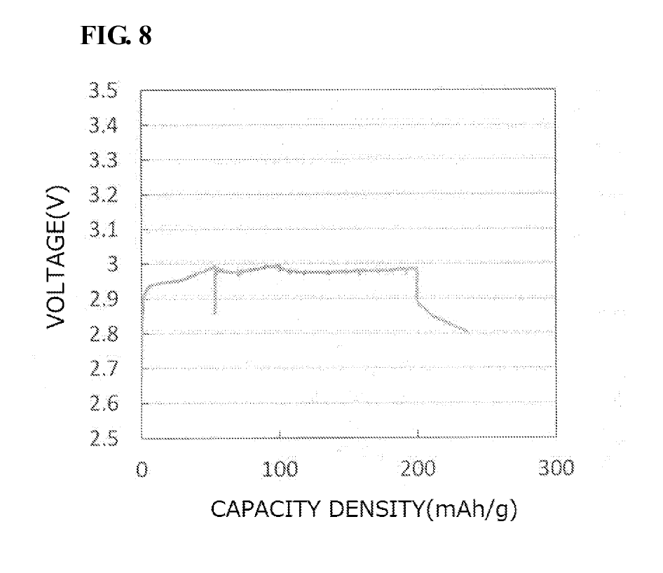

A molten salt battery was assembled and evaluated by the same methods as in Example 1 except that the moisture content in any one of the positive electrode, the negative electrode, and the molten salt was adjusted to 100 ppm, and the moisture content in the separator was adjusted to 1000 ppm. FIG. 8 shows a charge-discharge curve of the first cycle. Also, the moisture content in the molten salt measured by disassembling one battery immediately before a charge-discharge cycle test and taking out the molten salt from the battery was 400 ppm.

It can be understood from FIG. 8 that internal short-circuiting occurs in the molten salt battery of the comparative example at the first cycle, and thus the battery cannot be charged and discharged. Also, the battery was disassembled and the condition of the separator between the positive electrode and the negative electrode was confirmed. As a result, it was found that sodium dendrites grew to penetrate the separator at a plurality of positions.

### Comparative Example 2

A molten salt battery was assembled and evaluated by the same methods as in Example 1 except that the moisture content in any one of the positive electrode, the negative electrode, and the molten salt was adjusted to 500 ppm, and the moisture content in the separator was adjusted to 350 ppm. As a result, a voltage drop due to internal short-circuiting was confirmed at the first cycle. Also, the moisture content in the molten salt measured by disassembling one battery immediately before a charge-discharge cycle test and taking out the molten salt from the battery was 420 ppm.

### Comparative Example 3

A molten salt battery was assembled and evaluated by the same methods as in Example 1 except that the moisture contents in the positive electrode, the negative electrode, and the electrolyte were adjusted to 200 ppm, 350 ppm, and 100 ppm, respectively, and the moisture content in the separator was adjusted to 500 ppm. As a result, a voltage drop due to internal short-circuiting was confirmed at the first cycle. Also, the moisture content in the molten salt measured by disassembling one battery immediately before a charge-discharge cycle test and taking out the molten salt from the battery was 400 ppm.

### Comparative Example 4

A molten salt battery was assembled and evaluated by the same methods as in Example 1 except that the moisture contents in the positive electrode, the negative electrode, and the electrolyte were adjusted to 300 ppm, 400 ppm, and 200 ppm, respectively, and the moisture content in the separator was adjusted to 400 ppm. As a result, a voltage drop due to internal short-circuiting was confirmed at the first cycle. Also, the moisture content in the molten salt measured by disassembling one battery immediately before a charge-discharge cycle test and taking out the molten salt from the battery was 320 ppm.

### Example 3

A separator made of glass fibers and having a thickness of 80 μm was prepared as the separator. The average pore diameter was 2 μm to 3 μm, and porosity was 70%. The separator was cut into a size of 110 mm×110 mm, and 21 separators were prepared. A molten salt battery was assembled and evaluated by the same methods as in Example 1 except that the separators prepared as described above were used, and a compression load applied in the thickness direction of the separator in the battery was adjusted to 0.3 MPa. As a result, no internal short-circuiting was observed even after 50 cycles, and thus it was found that good charge-discharge characteristics are obtained. In addition, the discharge capacity density per gram of the positive electrode active material at the 50th cycle was 110 mAh/g.

### Example 4

A molten salt battery was assembled and evaluated by the same methods as in Example 3 except that a compression load applied in the thickness direction of the separator in the battery was adjusted to 0.5 MPa. As a result, no internal short-circuiting was observed even after 50 cycles, and thus it was found that good charge-discharge characteristics are obtained. In addition, the discharge capacity density per gram of the positive electrode active material at the 50th cycle was 115 mAh/g.

### Example 5

A molten salt battery was assembled and evaluated by the same methods as in Example 3 except that a compression load applied in the thickness direction of the separator in the battery was adjusted to 1 MPa. As a result, no internal short-circuiting was observed even after 50 cycles, and thus it was found that good charge-discharge characteristics are obtained. In addition, the discharge capacity density per gram of the positive electrode active material at the 50th cycle was 114 mAh/g.

### Example 6

A separator made of glass fibers and having a thickness of 200 μm was prepared as the separator. The average pore diameter was 5 μm to 6 μm, and porosity was 95%. The separator was cut into a size of 110 mm×110 mm, and 21 separators were prepared. A molten salt battery was assembled and evaluated by the same methods as in Example 1 except that the separators prepared as described above were used. However, a compression load applied in the thickness direction of the separator in the battery was adjusted to 0.3 MPa. As a result, no internal short-circuiting was observed even after 50 cycles, and thus it was found that good charge-discharge characteristics are obtained. In addition, the discharge capacity density per gram of the positive electrode active material at the 50th cycle was 109 mAh/g.

### Example 7

A molten salt battery was assembled and evaluated by the same methods as in Example 6 except that a compression load applied in the thickness direction of the separator in the battery was adjusted to 0.5 MPa. As a result, no internal short-circuiting was observed even after 50 cycles, and thus it was found that good charge-discharge characteristics are obtained. In addition, the discharge capacity density per gram of the positive electrode active material at the 50th cycle was 116 mAh/g.

### Example 8

A molten salt battery was assembled and evaluated by the same methods as in Example 6 except that a compression load applied in the thickness direction of the separator in the battery was adjusted to 1 MPa. As a result, no internal short-circuiting was observed even after 50 cycles, and thus it was found that good charge-discharge characteristics are obtained. In addition, the discharge capacity density per gram of the positive electrode active material at the 50th cycle was 118 mAh/g.

Table I summarizes the thicknesses of the separators made of glass fibers, compression loads, and discharge capacity densities in Examples 3 to 8. The results shown in Table I indicate that when the compression load applied in the thickness direction of the separators made of glass fibers is within a range of 0.3 MPa to 1.0 MPa, good discharge characteristics are obtained, and the compression load is particularly preferably within a range of 0.5 MPa to 1.0 MPa. Also, it can be understood that the preferred range of compression load is not much influenced by the thickness of the separator.

TABLE I

| | Thickness | Compression load | Discharge capacity density |
|---|---|---|---|
| | (μm) | (MPa) | (mAh/g) |
| Example 3 | 80 | 0.3 | 110 |
| Example 4 | 80 | 0.5 | 115 |
| Example 5 | 80 | 1 | 114 |
| Example 6 | 200 | 0.3 | 109 |
| Example 7 | 200 | 0.5 | 116 |
| Example 8 | 200 | 1 | 118 |

### Example 9

A molten salt battery was assembled and evaluated by the same methods as in Example 1 except that the moisture content in any one of the positive electrode, the negative electrode, the separator, and the molten salt was adjusted to less than 18 ppm. As a result, no internal short-circuiting was observed even after 50 cycles, and thus it was found that better charge-discharge characteristics than in Example 1 are obtained. Also, the moisture content in the molten salt measured by disassembling one battery immediately before a charge-discharge cycle test and taking out the molten salt from the battery was 18 ppm. In addition, the discharge capacity density per gram of the positive electrode active material at the 50th cycle was 119 mAh/g.

### INDUSTRIAL APPLICABILITY

According to a molten salt battery of the present invention, the growth of dendrites that penetrate a separator is suppressed, and thus internal short-circuiting is suppressed regardless of the type of the negative electrode material used, and excellent cycle characteristics can be achieved. The molten salt battery of the present invention is useful for, for example, a domestic or industrial large-size power storage apparatus, and a power source of an electric car or a hybrid car.

### REFERENCE SIGNS LIST

100: molten salt battery, 1: separator, 2: positive electrode, 2a: positive electrode lead piece, 3: negative electrode, 3a: negative electrode lead piece, 7: nut, 8: flange portion, 9: washer, 10: battery case, 11: electrode group, 12: container body, 13: cover portion, 14: external positive electrode terminal, 15: external negative electrode terminal, 16 safety valve

1. A molten salt battery comprising a positive electrode, a negative electrode, a separator interposed between the positive electrode and the negative electrode, and an electrolyte,
wherein the electrolyte includes a molten salt;
the molten salt contains at least contains as least one selected from the group consisting of compounds represented by N(SO₂X¹)(SO₂X²)·M (wherein X¹ and X² are each independently a fluorine atom or a fluoroalkyl group having 1 to 8 carbon atoms, and M is an alkali metal or an organic cation having a nitrogen-containing hetero-ring), the compound containing at least sodium ions as M; and
the moisture content We1 in the molten salt is 300 ppm or less in terms of mass ratio.

2. The molten salt battery according to claim 1, wherein the moisture content We1 is 200 ppm or less in terms of mass ratio.

3. (canceled)

4. A method for producing a molten salt battery, the method comprising:
a step of preparing a positive electrode having a moisture content Wp of 300 ppm or less in terms of mass ratio;
a step of preparing a negative electrode having a moisture content Wn of 400 ppm or less in terms of mass ratio;
a step of preparing, as an electrolyte, a molten salt having a moisture content We2 of 50 ppm or less in terms of mass ratio and containing at least sodium ions;
a step of preparing a separator having a moisture content Ws of 350 ppm or less in terms of mass ratio; and
a step of stacking the positive electrode and the negative electrode with the separator interposed therebetween to form an electrode group and impregnating the electrode group with the molten salt,
the molten salt contains at least contains as least one selected from the group consisting of compounds represented by N(SO₂X¹)(SO₂X²)·M (wherein X¹ and X² are each independently a fluorine atom or a fluoroalkyl group having 1 to 8 carbon atoms, and M is an alkali metal or an organic cation having a nitrogen-containing hetero-ring), the compound containing at least sodium ions as M.
